(19) United States
(12) Patent Application Publication
(10) Pub. No.: US 2021/0364938 A1
(43) Pub. Date: Nov. 25, 2021

(54) ELECTROPHOTOGRAPHIC PHOTORECEPTOR AND IMAGE FORMING APPARATUS EQUIPPED THEREWITH

(71) Applicant: SHARP KABUSHIKI KAISHA, Sakai City (JP)

(72) Inventors: Akiko KIHARA, Sakai City (JP); TAKAHIRO KURAUCHI, Sakai City (JP)

(21) Appl. No.: 17/315,940

(22) Filed: May 10, 2021

(30) Foreign Application Priority Data
May 22, 2020 (JP) 2020-089710

(51) Int. Cl. G03G 5/06; G03G 5/047; G03G 15/00

(52) U.S. Cl. CPC G03G 5/0696; G03G 15/75; G03G 5/047; G03G 5/061473

(57) ABSTRACT

The present invention provides an electrophotographic photoreceptor including at least a laminated photoreceptive layer in which a charge generating layer containing a charge generating substance and a charge transporting layer containing a charge transporting substance are laminated in this order on a substrate, where the charge generating substance is a titanyl phthalocyanine showing diffraction peaks at least at Bragg angles (2θ±0.2°) 7.3°, 9.4°, 11.6°, 24.2° and 27.3° in an X-ray diffraction spectrum using CuKα ray, and the laminated photoreceptive layer includes an optical absorption spectrum that has a maximum absorption at 800 to 850 nm and where a ratio Abs_{860 nm}/Abs_{780 nm} of a peak intensity at 860 nm (Abs_{860 nm}) to a peak intensity at 780 nm (Abs_{780 nm}) is 0.6 or more to 1.2 or less when a minimum absorbance at 400 to 800 nm is calibrated to 0.

### BACKGROUND OF THE INVENTION

### Field of the Invention

The present invention relates to an electrophotographic photoreceptor and an image forming apparatus equipped therewith. More specifically, the present invention relates to an electrophotographic photoreceptor that contains titanyl phthalocyanine having a specific X-ray diffraction pattern as a charge generating substance and includes a photoreceptive layer having a special optical absorption spectrum, and relates to an image forming apparatus equipped with the electrophotographic photoreceptor.

### Description of the Background Art

Electrophotographic image forming apparatuses for forming an image using an electrophotographic technology are widely used in copiers, printers, facsimiles, and the like.

An electrophotographic photoreceptor (hereinafter, also referred to as a “photoreceptor”) used in an electrophotographic process is configured such that a photoreceptive layer containing a photoconductive material is laminated on a substrate.

Recently, a photoreceptor (also referred to as “organic photoreceptor”) having a photoreceptive layer containing an organic photoconductive material as a main component has been progressively researched and developed, and is currently the mainstream of the photoreceptors.

For the organic photoreceptor, a configuration in which a monolayered photoreceptive layer obtained by dispersing a charge generating substance and a charge transporting substance (also referred to as “charge transferring substance”) in a binder resin (also referred to as “binding resin”, “binding agent resin”) is provided on a substrate (also referred to as “conductive support”), and a configuration including a laminated photoreceptive layer in which a charge generating layer obtained by dispersing a charge generating substance in a binder resin and a charge transporting layer obtained by dispersing a charge transporting substance in a binder resin are laminated in this order, have been proposed. Among the configurations, the latter function separable-type photoreceptor has excellent electrophotographic property and durability and high freedom in selecting a material, and is easy to variously design for photoreceptor properties, and widely utilized.

Among them, for an organic photoreceptor composed of a charge generating layer in which a specific crystalline titanyl phthalocyanine as a charge generating substance is dispersed in a vapor deposited film or a resin, and a charge transporting layer in which a low-molecular-weight organic compound as a charge transporting substance is dispersed in a resin, there have been a lot of proposals.

The organic photoreceptors have high sensitivity to long-wavelength light, low residual potential, high electrifiability, and excellent electrostatic property, but have a problem that these advantages cannot be maintained due to repeated electric fatigue.

In recent years, image forming apparatuses such as a copier have been increasingly demanded to be speeded up and downsized.

For example, as a method for the speeding up, a tandem method is widely adopted, in which image forming units such as a photoreceptor unit, an electrification unit, an exposure unit, a development unit, a cleaning unit, and a charge eliminating unit are arranged for yellow, magenta, cyan, and black image forming elements.

Thus, for achieving downsizing of the apparatus, it is necessary to downsize each image forming unit itself and to decrease a diameter of the photoreceptor. Conventionally, the diameter of the photoreceptor has been demanded to be increased for prolonging a maintenance cycle, but it is essential to decrease the diameter of the photoreceptor due to adoption of the tandem method. The decrease in the photoreceptor diameter has many technical problems in prolonging a life (life span) of the photoreceptor because the repeated electric fatigue is more severe than ever. Such deterioration is because of composite deterioration of various materials, and although the cause has not been clarified, one reason is that light resistance of the photoreceptor is insufficient.

In normal use, when the photoreceptor is exposed to light, the photoreceptor is exposed not only to a light source inside a copier. During maintenance of replacement parts such as peripheral members or during paper jam in a machine, the photoreceptor is exposed to external lights. The light fatigue due to these external lights causes more damaging than the electric fatigue in the machine, resulting in image deterioration. Additionally, it is necessary to take photoreceptor deterioration due to light into consideration in the production process, to use the copier under a short wavelength-cut fluorescent lamp, and to take sedulous care, and there is a concern of lowered productivity.

For these problems, various techniques have been proposed.

Japanese Unexamined Patent Application Publication No. H10-048856 (Patent Document 1) and Japanese Unexamined Patent Application Publication No. H11-184108 (Patent Document 2) propose techniques of adding an ultraviolet absorber showing a maximum absorption wavelength at 380 to 480 nm to a photoreceptive layer.

Japanese Unexamined Patent Application Publication No. 2010-164639 (Patent Document 3) proposes a technique of adding an electron transporting material (electron transporting substance) having a specific structure showing a maximum absorption wavelength at 300 to 370 nm and no absorption wavelength at 730 to 800 nm.

However, all of the techniques are methods of adding an additive to the photoreceptive layer, and although magnitude of influence varies, they still have an action of trapping the charge transport.

In addition, even if a small amount of low-molecular-weight compound is added to the photoreceptive layer, there is a problem of lowered printing durability.

As described above, recently, the image forming apparatus such as a copier is still insufficient for demands of speeding up, downsizing, decrease of photoreceptor diameter, and long life.

Thus, an object of the present invention is to provide an electrophotographic photoreceptor that is a photoreceptor using a known crystalline titanyl phthalocyanine as a charge generating substance, in which light resistance is excellent, sensitivity is not deteriorated even through a long-term repeated energization fatigue over its life, and stable image properties can be maintained for a long term, and to provide an image forming apparatus equipped with the electrophotographic photoreceptor, which can stably form an image in a long-term use without deteriorating printing durability of a photoreceptive layer in speeding up, downsizing, and decrease of a photoreceptor diameter.

### SUMMARY OF THE INVENTION

As a result of intensive studies to solve the above problems, the present inventors have found that, in a photoreceptor using a titanyl phthalocyanine having a specific X-ray diffraction spectrum as a charge generating substance, a photoreceptive layer has a specific optical absorption spectrum, thereby light resistance of the photoreceptor is remarkably improved even if an ultraviolet absorber is not added to the photoreceptive layer or even if an addition amount of the ultraviolet absorber is reduced, and stable image properties can be maintained for a long term, and the present invention has been completed.

In such a way, the present invention provides an electrophotographic photoreceptor including at least a laminated photoreceptive layer in which a charge generating layer containing a charge generating substance and a charge transporting layer containing a charge transporting substance are laminated in this order on a substrate, wherein the charge generating substance is a titanyl phthalocyanine showing diffraction peaks at least at Bragg angles (2θ±0.2°) 7.3°, 9.4°, 11.6°, 24.2° and 27.3° in an X-ray diffraction spectrum using CuKα ray, and the laminated photoreceptive layer includes an optical absorption spectrum that has a maximum absorption at 800 to 850 nm and where a ratio Abs_{860 nm}/Abs_{780 nm} of a peak intensity at 860 nm (Abs_{860 nm}) to a peak intensity at 780 nm (Abs_{780 nm}) is 0.6 or more to 1.2 or less when a minimum absorbance at 400 to 800 nm is calibrated to 0.

In addition, the present invention provides an image forming apparatus including at least the aforementioned electrophotographic photoreceptor, an electrifier for electrifying the electrophotographic photoreceptor, an exposer for exposing the electrified electrophotographic photoreceptor to form an electrostatic latent image, a developer for developing the electrostatic latent image formed by the exposure to form a toner image, a transferer for transferring the toner image formed by the development onto a recording medium, a fuser for fusing the transferred toner image onto the recording medium to form an image, a cleaner for removing and recovering a toner remaining on the electrophotographic photoreceptor, and a charge eliminator for eliminating surface charges remaining on the electrophotographic photoreceptor.

The present invention can provide an electrophotographic photoreceptor using a known crystalline titanyl phthalocyanine as a charge generating substance, in which light resistance is excellent, sensitivity is not deteriorated even through a long-term repeated energization fatigue over its life, and stable image properties can be maintained for a long term, and provide an image forming apparatus equipped with the electrophotographic photoreceptor, which can stably form an image in a long-term use without deteriorating printing durability of a photoreceptive layer in speeding up, downsizing, and decrease of the photoreceptor diameter.

The photoreceptor according to the present invention exerts the aforementioned effects better, when any one of the following conditions (1) to (4) is satisfied.

(1) The ratio Abs_{860 nm}/Abs_{780 nm} is 0.75 or more to 1 or less.
(2) The titanyl phthalocyanine has an average particle diameter D (50%) of 0.15 to 0.3 μm.
(3) The charge transporting substance is a triarylamine dimer compound represented by general formula (1) (described in detail in section “Charge Transporting Layer”), or a stilbene derivative represented by general formula (2) (described in detail in section “Charge Transporting Layer”).
(4) An undercoat layer is provided between the substrate and the laminated photoreceptive layer.

### BRIEF DESCRIPTION OF THE DRAWINGS

FIG. 1 is a diagram presenting an optical absorption spectrum of a photoreceptive layer of a photoreceptor (Example 1) according to the present invention.

FIG. 2 is a schematic sectional view illustrating a configuration of a main part of a photoreceptor (laminated photoreceptor) F01 according to the present invention.

FIG. 3 is a schematic side view illustrating a configuration of a main part of an image forming apparatus 100 according to the present invention.

FIG. 4 is a diagram presenting an X-ray diffraction spectrum pattern of a titanyl phthalocyanine in Production Example 1.

### DESCRIPTION OF THE PREFERRED EMBODIMENTS

### (1) Photoreceptor

The photoreceptor according to the present invention includes at least a laminated photoreceptive layer in which a charge generating layer containing a charge generating substance and a charge transporting layer containing a charge transporting substance are laminated in this order, on a substrate, and is characterized in that

the charge generating substance is a titanyl phthalocyanine showing diffraction peaks at least at Bragg angles (2θ±0.2°) 7.3°, 9.4°, 11.6°, 24.2° and 27.3° in an X-ray diffraction spectrum using CuKα ray, and

the laminated photoreceptive layer includes an optical absorption spectrum that has a maximum absorption at 800 to 850 nm and where a ratio Abs_{860 nm}/Abs_{780 nm} of a peak intensity at 860 nm (Abs_{860 nm}) to a peak intensity at 780 nm (Abs₇₈₀ nm) is 0.6 or more to 1.2 or less when a minimum absorbance at 400 to 800 nm is calibrated to 0.

When the photoreceptive layer of the photoreceptor according to the present invention has the aforementioned optical absorption spectrum, a λₘₐₓ of a phthalocyanine pigment shows strong absorption on a long wavelength side, which suggests that an intermolecular interaction of the phthalocyanine pigment becomes stronger.

When the photoreceptive layer is exposed to external light, the photoreceptive layer is activated to an extent equivalent to an absorbed light energy and becomes an excited state, and the stabler the excited state is, the greater an influence on an image is. Thus, it is assumed that a manner of forming a structure that the photoreceptive layer can be rapidly deactivated from this excited state to a ground state affects light resistance of the photoreceptive layer.

In the photoreceptor according to the present invention, when the photoreceptive layer has the aforementioned optical absorption spectrum, charges exposed to external light and excited move between ππ bonds of the phthalocyanine pigment. The photoreceptive layer becomes easy to rapidly deactivate to the ground state, and as a result, it is inferred that a photoreceptive layer having good light resistance is formed.

That means, the photoreceptor according to the present invention is characterized in that the laminated photoreceptive layer disposed on the substrate and containing a specific titanyl phthalocyanine as the charge generating substance has a specific optical absorption spectrum.

First, the titanyl phthalocyanine and the laminated photosensitive layer (hereinafter, also referred to as “photoreceptive layer”) will be explained, and then the photoreceptor and the image forming apparatus equipped with the photoreceptor will be explained.

### Titanyl Phthalocyanine

The Titanyl Phthalocyanine used as the charge generating substance in the present invention shows diffraction peaks at least at Bragg angles (2θ±0.2°) 7.3°, 9.4°, 11.6°, 24.2° and 27.3° in the X-ray diffraction spectrum using CuKα ray.

The titanyl phthalocyanine is represented by the following formula (A).

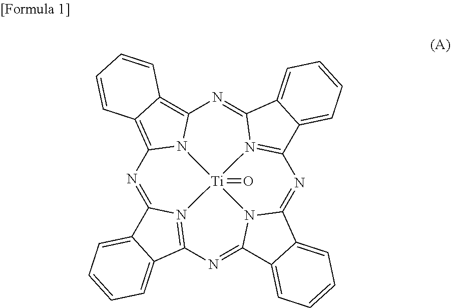

The oxotitanium phthalocyanine represented by formula (A) can be produced e.g. by known synthesis methods described in Japanese Patent Laid-Open No. H6-293769, Japanese Patent Laid-Open No. 2003-183534, Japanese Patent Laid-Open No. H7-271073, and Frank H, Moser and Arthur L. Thomas, “Phthalocyanine Compounds”, Reinhold Publishing Corporation (New York), 1963.

The known synthesis methods include a method using a titanium halide as a starting raw material and a method using no titanium halide, but the present inventors have confirmed that the excellent effect of the present invention can be obtained regardless of the starting raw material and the method of the synthesis as long as the oxotitanium phthalocyanine has the characteristics of the aforementioned X-ray diffraction spectrum. However, as will be described later, when the oxotitanium phthalocyanine contains a halogen such as chlorine, an electrifying performance of the photoreceptor is adversely affected in some cases, and therefore the oxotitanium phthalocyanine is preferably derived from a raw material containing no halogen such as chlorine.

A synthesis method will be described as an example below. Note that the following synthetic route is merely an example, and the present invention is not limited to this synthetic route.

A phthalonitrile and a titanium alkoxide such as tetrabutoxytitanium are reacted in the presence of urea by stirring while maintaining the temperature at 150° C. for at least 5 hours. A titanyl phthalocyanine produced after completion of the reaction is filtered off. An obtained product is washed with a solvent e.g. an alcohol such as methanol, ethanol, n-propanol and butanol, a chlorine-based hydrocarbon such as dichloroethane and chloroform, an ether such as dimethyl ether, diethyl ether and tetrahydrofuran, and a ketone such as acetone and methyl ethyl ketone, or the like to obtain a titanyl phthalocyanine. Since the titanyl phthalocyanine is not dissolved in the aforementioned solvents and impurities adhering to the titanyl phthalocyanine are dissolved, the residual impurities can be reduced to the utmost limit by repeating washing.

In addition, an o-phthalonitrile and a titanium tetrachloride are heat-melted or heat-reacted in a suitable solvent such as α-chloronaphthalene to synthesize a dichlorotitanium phthalocyanine, which is then hydrolyzed with a base or water to obtain a titanyl phthalocyanine.

Furthermore, isoindoline and a titanium tetraalkoxide such as tetrabutoxytitanium are heat-reacted in a suitable solvent such as N-methylpyrrolidone to obtain an oxotitanium phthalocyanine. The titanyl phthalocyanine may contain a phthalocyanine derivative in which a hydrogen atom of a benzene ring is substituted with chlorine, fluorine, a substituent such as a nitro group, a cyano group, and a sulfone group.

The titanyl phthalocyanine obtained in this way is treated with an organic solvent immiscible with water such as dichloroethane in the presence of water to obtain a crystalline titanyl phthalocyanine used as a charge generating substance in the present invention.

Examples of the treatment method (crystal transformation method) include a method in which the titanyl phthalocyanine is swollen with water and treated with an organic solvent, a method in which water is added to an organic solvent, to which a titanyl phthalocyanine powder is added without performing the swelling, and the like.

As the method of swelling the titanyl phthalocyanine with water, for example, the titanyl phthalocyanine is dissolved in 10 to 30 times the amount of concentrated sulfuric acid, and if insoluble matters appear, the insoluble matters are removed by filtration or the like, and precipitated in cooled water. Subsequently, the obtained titanyl phthalocyanine is filtered with ion-exchanged water or the like to remove acids, and repeatedly washed until becoming neutral to obtain a wet cake (also referred to as “wet paste”).

When the titanyl phthalocyanine is swollen with water, a known stirrer/disperser such as a homomixer, a paint mixer, a ball mill, and a sand mill may be used.

In this way, the amorphous titanyl phthalocyanine (low crystalline titanyl phthalocyanine) can be transformed into a titanyl phthalocyanine crystal having specific diffraction peaks.

For more detail, a crystal transformation method for the titanyl phthalocyanine will be explained.

Specifically, the aforementioned wet cake-like amorphous titanyl phthalocyanine (low crystalline titanyl phthalocyanine) is mixed and stirred in the presence of water and an organic solvent without drying, to obtain a desired crystal form.

The organic solvent used herein may be the tetrahydrofuran alone, or may be a mixed solvent of the tetrahydrofuran with one selected from toluene, methylene chloride, carbon disulfide, orthodichlorobenzene, and 1,1,2-trichloroethane as long as a desired crystal form can be obtained. Also, the titanyl phthalocyanine according to the present invention can be obtained by stirring the wet cake-like amorphous titanyl phthalocyanine for a sufficient time, or by milling the wet cake-like amorphous titanyl phthalocyanine while applying a mechanical stress.

Examples of the apparatus used for this treatment include a general stirrer, and besides, a homomixer, a paint mixer, a disperser, an agitator, a ball mill, a sand mill, an attritor, an ultrasonic disperser, and the like. After the treatment, the titanyl phthalocyanine may be filtered, then washed and isolated using methanol, ethanol, water, or the like by known methods.

Preferably, the titanyl phthalocyanine used as the charge generating substance in the present invention has an average particle diameter D (50%) of 0.15 to 0.3 μm.

For example, if the titanyl phthalocyanine is pulverized (crushed) during dispersion of a charge generating layer-forming coat liquid described later to have an average particle diameter of less than 0.15 μm, a carrier generation efficiency decreases, sensitivity of the photoreceptor tends to become poor. In addition, when the pigment is excessively sheared during dispersion, coating defects are readily caused during film formation, and therefore it becomes difficult to stably generate charges in long-term use. On the other hand, if the average particle diameter is larger than 0.3 μm, a particle size distribution tends to become poor in long-term storage, and coating defects are readily caused during film formation of the charge generating layer.

More preferably, the titanyl phthalocyanine has an average particle diameter of 0.18 to 0.28 μm.

A method for measuring the average particle diameter will be describe in detail in Examples.

### Photoreceptive Layer

The photoreceptive layer of the photoreceptor according to the present invention includes an optical absorption spectrum that has a maximum absorption (λₘₐₓ) at 800 to 850 nm, and where a ratio Abs_{860 nm}/Abs_{780 nm} of a peak intensity at 860 nm (Abs_{860 nm}) to a peak intensity at 780 nm (Abs_{780 nm}) is 0.6 or more to 1.2 or less when a minimum absorbance at 400 to 800 nm is calibrated to 0.

If the maximum absorption wavelength (λₘₐₓ) is lower than 800 nm, light resistance and charge reduction due to repeated use may become poor. On the other hand, also if the maximum absorption wavelength (λₘₐₓ) is higher than 850 nm, the light resistance may be decreased. It is most suitable that the maximum absorption wavelength is within the specified range in the present invention.

A preferable maximum absorption wavelength is 800 to 830 nm.

In addition, when the peak intensity ratio is less than 0.6, the light resistance is particularly poor, and an ultraviolet absorber should be introduced into a charge transporting layer (CTL). It is assumed that this is because the maximum absorption wavelength (λₘₐₓ) shifts to a lower wavelength side and the peak intensity ratio decreases, thereby the interaction between the titanyl phthalocyanines is weakened, and when the photoreceptor is exposed to strong external light and when the photoreceptor is exposed to repeated electric fatigue, residual carriers generated in the charge generating layer remain without deactivation. On the contrary, when the peak intensity ratio is higher than 1.2, the maximum absorption wavelength (λₘₐₓ) shifts to a lower wavelength side, and a repeated VL (surface potential) increases in some cases.

The preferable peak intensity ratio is 0.75 or more to 1 or less.

Such an optical absorption spectrum (absorbance) of the photoreceptive layer can be controlled by adjusting shearing conditions (dispersion method, dispersion time, and diameter, amount, and material of the medium) during synthesis of the charge generating substance and dispersion of the charge generating layer-forming coat liquid.

It is important to reduce impurities as much as possible in a synthetic pathway of the charge generating substance. For example, for a washed state in a deoxidizing step, it is important to reduce a sulfate ion concentration closure to pH 7.0, and if the impurities remain in this step, the maximum absorption wavelength (λₘₐₓ) in the absorption spectrum becomes hard to adjust to a higher wavelength side. In the presence of the impurities, a crystal structure has a weak interaction between phthalocyanines, and therefore it is important to reduce impurities for maintaining stable electric properties in long-term use.

In addition, the residual amount of the impurities can be reduced by selecting crystallization conditions and a crystallization solvent in a crystallization step of the titanyl phthalocyanine. By adding toluene as the crystallization solvent, the impurities can be more strongly washed, but addition of a high boiling point solvent allows a large amount of residual solvent to remain in the crystal, affecting the properties in some cases. In the synthesis step, it is preferable to suppress impurities and to reduce the residual solvent.

On the other hand, adjustment in accordance with the shearing conditions for dispersion is also possible.

Shearing is performed using a pulverizer including a spherical medium having a medium diameter of 0.1 to 3.0 mm, preferably 0.1 to 2.0 mm. If the medium diameter is larger than 2.0 mm, a pulverization efficiency tends to decrease. Thus, there will be harmful effects, e.g. the maximum absorption wavelength (λₘₐₓ) cannot be adjusted within the specified range in the present invention, or the phthalocyanine is excessively sheared by extending the dispersion time, the properties are deteriorated, the particle diameter is not decreased, and aggregates are formed.

Besides, the pulverization efficiency is changed depending on the material of the medium, the optimum conditions are affected by the phthalocyanine pigment, and therefore, the optimum dispersion condition should be selected for each material. As long as the maximum absorption wavelength is within the specified range in the present invention, adjustment from the synthesis step, adjustment from the shearing condition, and the like are not particularly limited, and the effects described in the present invention can be maintained.

### Electrophotographic Photoreceptor

The photoreceptor according to the present invention includes at least the laminated photoreceptive layer in which the charge generating layer containing the charge generating substance and the charge transporting layer containing the charge transporting substance are laminated in this order, on the substrate.

Hereinafter, the photoreceptors according to the present invention will be explained with reference to the figures, but the present invention is not limited to these photoreceptors.

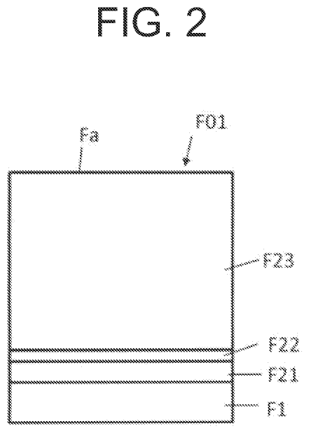

FIG. 2 is a schematic sectional view illustrating a configuration of the main part of the photoreceptor (laminated photoreceptor) F01 according to the present invention.

The laminated photoreceptor F01 includes the photoreceptive layer in which an undercoat layer F21, a charge generating layer F22 containing a charge generating substance, and a charge transporting layer F23 containing a charge transporting substance are laminated in this order, on a substrate F1. In the figure, Fa indicates a surface of the photoreceptor.

### Substrate F1

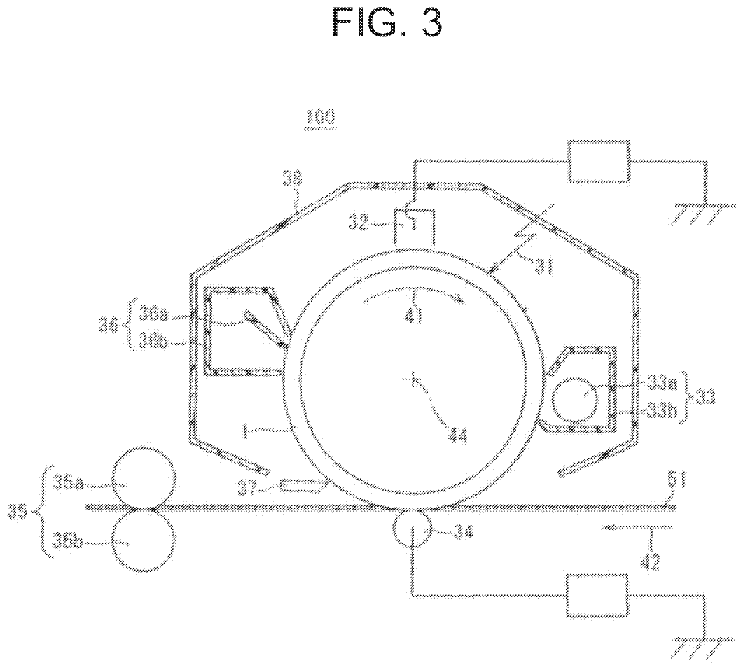

The substrate (also referred to as “conductive substrate” or “conductive support”) has a function as an electrode of the photoreceptor and a function as a support member, and the constituent material of the substrate is not particularly limited as long as the material is used in the art. Specific examples of the material include a metal material such as aluminum, aluminum alloy, copper, zinc, stainless steel and titanium, as well as a polymer material such as polyethylene terephthalate, nylon and polystyrene, a hard paper, and a glass, in which their surfaces are laminated with a metal foil, vapor-deposited with a metal, or vapor-deposited or coated with a layer of a conductive compound such as a conductive polymer, tin oxide and indium oxide, and the like. Among these materials, aluminum is preferable from the viewpoint of ease of processing, and aluminum alloys such as JIS3003 series, JIS5000 series, and JIS6000 series are particularly preferable. A shape of the conductive support is not limited to the cylindrical shape (drum shape) as illustrated in FIG. 3, and may be a sheet shape, a columnar shape, an endless belt shape, or the like.

In addition, as necessary, a surface of the conductive support may be subjected to anodic oxidation coating, surface treatment with chemicals or hot water, coloring, or irregular reflection treatment such as surface roughening without affecting an image quality, for preventing interference fringes due to laser beam.

### Undercoat Layer F21

Preferably, the photoreceptor according to the present invention includes an undercoat layer (also referred to as “intermediate layer”) between the substrate and the laminated photoreceptive layer.

The undercoat layer generally covers unevenness of the surface of the substrate to make the surface uniform and to improve the film formability of the laminated photoreceptive layer, so that removal of the photoreceptive layer from the conductive support can be suppressed, and adhesiveness between the substrate and the photoreceptive layer can be improved. Specifically, charge injection from the substrate into the photoreceptive layer is prevented, and decrease in the electrifiability of the photoreceptive layer is prevented, so that image fogging (so-called black spots) can be prevented. The undercoat layer can be formed by e.g. a process in which a binder resin is dissolved or dispersed in an appropriate solvent to prepare a coat liquid for the undercoat layer, this coat liquid is applied on the surface of the substrate, and the organic solvent is removed by drying.

Examples of the binder resin include an acetal resin, a polyamide resin, a polyurethane resin, a polyester resin, an acrylic resin, an epoxy resin, a phenol resin, a melanin resin, a urethane resin, and the like. Among these binder resins, the binder resin is preferably the polyamide resin, particularly preferably an alcohol-soluble nylon resin and a polyamide resin containing a piperazine-based compound, because the binder resin is demanded to have properties such as insolubility and unswelling property in the solvent used in forming the photoreceptive layer on the undercoat layer, excellent adhesiveness with the conductive support, and flexibility.

Examples of the alcohol-soluble nylon resin include a homopolymerized or copolymerized nylon such as 6-nylon, 66-nylon, 610-nylon, 11-nylon and 12-nylon, a chemically-modified nylon such as N-alkoxymethyl-modified nylon, and the like.

In addition, undercoat layer may be a hardened film by using a hardener for crosslinking the binder resin. The hardener is preferably a blocked isocyanate from the viewpoint of storage stability and an electric property of the coat liquid.

Examples of the solvent include water, a lower alcohol such as methanol, ethanol, n-propyl alcohol, isopropyl alcohol, n-butanol, 2-butanol and isobutanol, a ketone such as acetone, cyclohexanone and 2-butanone, an ether such as tetrahydrofuran, dioxane, ethylene glycol and diethyl ether, a halogenated hydrocarbon such as methylene chloride and ethylene chloride. In relation to these solvents, appropriate solvents are selected depending on solubility of the binder resin, surface smoothness of the undercoat layer, and the like, and one type of the solvent can be used alone or two or more types can be used in combination.

Among these solvents, for example, a non-halogen organic solvent can be suitably used in consideration of the global environment.

The undercoat layer-forming coat liquid may contain a metal oxide particle. The metal oxide particle can easily adjust a volume resistivity value of the undercoat layer, further suppress charge injection into the charge generating layer, and maintain the electric property of the photoreceptor under various environments.

Examples of a material that can be used as the metal oxide particle include titanium oxide, aluminum oxide, aluminum hydroxide, tin oxide, and the like.

A ratio (A/B) of a total mass A of the binder resin and the metal oxide particle to a mass B of the solvent in the undercoat layer-forming coat liquid is e.g. preferably about 1/99 to 30/70, particularly preferably about 2/98 to 40/60. In addition, a ratio (C/D) of a mass C of the binder resin to a mass D of the metal oxide particle is e.g. preferably about 90/10 to 1/99, particularly preferably about 70/30 to 5/95.

As a method for applying the coat liquid for the undercoat layer, it is only necessary to appropriately select an optimum method in consideration of physical properties and productivity of the coat liquid, and examples of the method include a spray method, a bar coating method, a roll coating method, a blade method, a ring method, an immersion coating method, and the like. Among these methods, in the immersion coating method, the substrate is immersed in a coating bath filled with a coat liquid, and then raised at a constant speed or a continuously changing speed to form a layer on the surface of the substrate. This immersion coating method is relatively simple and excellent in the productivity and the cost, and therefore can be suitably used for producing the photoreceptor. An apparatus used in the immersion coating method may be equipped with a coat liquid disperser typified by an ultrasonic wave generator for the purpose of stabilizing dispersibility of the coat liquid.

The solvent in the coat film may be removed by natural drying, but may be forcibly removed by heating.

A temperature in such a drying step is not particularly limited as long as the solvent used can be removed, but the temperature is suitably about 50 to 140° C., and particularly preferably about 80 to 130° C.

If the drying temperature is lower than 50° C., the drying time is prolonged, and the solvent does not sufficiently evaporate and remains in the photoreceptive layer in some cases. In addition, if the drying temperature is higher than about 140° C., the electric property of the photoreceptor during repeated use becomes poor, and an obtained image is deteriorated in some cases.

Such a temperature condition is common in formation of not only the undercoat layer but also a layer such as a photoreceptive layer described later, and other treatments.

A film thickness of the undercoat layer is not particularly limited, but is preferably 0.01 to 20 μm, more preferably 0.05 to 10 μm.

If the film thickness of the undercoat layer is less than 0.01 μm, it is impossible to obtain sufficient effects on the blocking property against electron injection from the conductive substrate side and the countermeasure against interference fringes due to light scattering in some cases. On the other hand, if the film thickness of the undercoat layer is more than 20 μm, the change in sensitivity increases during continuous printing, and therefore the change in image density increases in some cases.

### Charge Generating Layer F22

The charge generating layer has a function of generating charges by absorbing light emitted from a light emitter, such as a light beam like a semiconductor laser in an electrophotographic apparatus such as an image forming apparatus. The charge generating layer contains a charge generating substance as a main component and, as necessary, contains a binder resin and additives.

As the charge generating substance, the aforementioned titanyl phthalocyanine is used, which may be used in combination with another charge generating substance known in the art, and since the properties of the photoreceptor according to the present invention are improved depending on a content of oxo-phthalocyanine, the higher for the content, the better, and the content is preferably at least 80%.

A method for forming the charge generating layer is preferably a method in which the charge generating substance is dispersed in a binder resin solution obtained by mixing a binder resin in a solvent by a conventionally known method, and a coat liquid for the charge generating layer is applied on the undercoat layer. This method will be explained below.

Examples of other charge generating substances include: organic photoconductive materials e.g. type a, type B, type Y amorphous titanyl phthalocyanines having a different crystal form from that of the aforementioned titanyl phthalocyanine or another metal phthalocyanine such as gallium, an azo-based pigment such as a monoazo-based pigment, a bisazo-based pigment and a trisazo-based pigment, an indigo-based pigment such as indigo and thioindigo, a perylene-based pigment such as peryleneimide and perylenic acid anhydride, a polycyclic quinone-based pigment such as anthraquinone and pyrenequinone, a phthalocyanine-based pigment such as a metallic phthalocyanine like oxotitanium phthalocyanine and a non-metal phthalocyanine, a squarylium pigment, a pyrylium salt, a thiopyrylium salt, and a triphenylmethane pigment; and inorganic photoconductive materials such as selenium and amorphous silicone; and the like. A charge generating substance showing sensitivity at an exposure wavelength range can be appropriately selected for use.

The binder resin is not particularly limited, and a bindable resin used in the art and the binder resin describe as an example for the aforementioned undercoat layer can be used. A binder resin excellent in compatibility with the charge generating substance is preferable.

Specific examples of the binder resin include polyester, polystyrene, polyurethane, a phenol resin, an alkyd resin, a melamine resin, an epoxy resin, a silicone resin, an acrylic resin, a methacrylic resin, polycarbonate, polyarylate, a phenoxy resin, polyvinyl butyral (PVB), polyvinyl formal, a copolymer resin containing two or more of repeating units constituting these resins, and the like. Examples of the copolymer resin include insulating resins such as vinyl chloride-vinyl acetate copolymer resin, a vinyl chloride-vinyl acetate-maleic anhydride copolymer resin, and an acrylonitrile-styrene copolymer resin, and the like. One of these binder resins may be used alone or two or more of these binder resins may be used in combination.

In the present invention, among the aforementioned binder resins, a binder resin obtained by an acetalization reaction of two or more aldehydes with polyvinyl alcohol and having a mass average molecular weight of 60,000 or more to 200,000 or less is preferable.

If the mass average molecular weight is less than 60,000, dispersibility of the titanyl phthalocyanine according to the present invention becomes poor, defects in film formability is readily caused, and problems in dispersion stability during long-term storage is caused, in some cases. On the other hand, if the mass average molecular weight is more than 200,000, a viscosity of the dispersed coat liquid increases, so that a crystal system of the titanyl phthalocyanine collapses, in some cases.

A more preferable range of the mass average molecular weight is 80,000 or more to 120,000 or less.

The mass average molecular weight can be measured by a known method.

Examples of the solvent include: a halogenated hydrocarbon such as dichloromethane and dichloroethane; a ketone such as acetone, methyl ethyl ketone and cyclohexanone; an ester such as ethyl acetate and butyl acetate; an ether such as tetrahydrofuran (THF) and dioxane; an alkyl ether of ethylene glycol, such as 1,2-dimethoxyethane; an aromatic hydrocarbon such as benzene, toluene and xylene; an aprotonic polar solvent such as N,N-dimethylformamide and N,N-dimethylacetamide; and the like. One of these solvents may be used alone or two or more of these solvents may be used in combination.

Among these solvents, for example, a non-halogen organic solvent can be suitably used in consideration of the global environment.

Similar to the undercoat layer, a disperser such as a paint shaker, a ball mill and a sand mill can be used to dissolve or disperse the charge generating substance in the binder resin solution. At this time, impurities are generated from a container and members constituting the disperser due to wear or the like, and therefore it is preferable to appropriately set dispersion conditions to keep the impurities from getting mixed with the coat liquid.

Preferably, a ratio (E/F) of a mass E of the charge generating substance to a mass F of the binder resin is e.g. about 80/20 to 55/45.

If the ratio (E/F) is higher than 80/20, i.e. if the mass E of the charge generating substance increases, the amount of the charge generating substance is too large, and dispersion stability of the charge generating substance in the binder resin becomes poor in some cases. On the other hand, if the ratio (E/F) is lower than 55/45, i.e. if the mass E of the charge generating substance decreases, a charge generation efficiency decreases, and the sensitivity becomes poor in some cases.

A more preferable ratio is about 60/40 to 70/30.

A film thickness of the charge generating layer is not particularly limited, but is preferably 0.05 to 5 μm, more preferably 0.1 to 1 μm.

If the film thickness of the charge generating layer is less than 0.05 μm, a light absorption efficiency decreases and the sensitivity of the photoreceptor decrease in some cases. On the other hand, if the film thickness of the charge generating layer is more than 5 μm, the charge transfer inside the charge generating layer is at a rate-limiting stage in a process of erasing the charges on the photoreceptive layer surface, and the sensitivity of the photoreceptor decreases in some cases.

### Charge Transporting Layer F23

The charge transporting layer has a function of receiving the charges generated by the charge generating substance and transporting the charges to the surface of the photoreceptor (Fa in FIG. 2), and contains the charge transporting substance, the binder resin, and, if necessary, additives.

The charge transporting substance is not particularly limited, and compounds used in the art can be used.

Specific examples of the charge transporting substance include a carbazole derivative, a pyrene derivative, an oxazole derivative, an oxadiazole derivative, a thiazole derivative, a thiadiazol derivative, a triazole derivative, an imidazole derivative, an imidazolone derivative, an imidazolidine derivative, a bisimidazolidine derivative, a styryl compound, a hydrazone compound, a polycyclic aromatic compound, an indole derivative, a pyrazoline derivative, an oxazolone derivative, a benzimidazole derivative, a quinazoline derivative, a benzofuran derivative, an acridine derivative, a phenazine derivative, an aminostilbene derivative, a triarylamine derivative, a triarylmethane derivative, a phenylenediamine derivative, a stilbene derivative, an enamine derivative, a benzidine derivative, a polymer having a group derived from these compounds on a main chain or a side chain (poly-N-vinylcarbazole, poly-1-vinylpyrene, ethylcarbazole-formaldehyde resin, triphenylmethane polymer, poly-9-vinyl anthracene, or the like), a polysilane, and the like. One of these charge transporting substances may be used alone or two or more of these charge transporting substances may be used in combination.

Among these charge transporting substances, a triarylamine dimer compound represented by general formula (1) and a stilbene derivative represented by general formula (2) are particularly preferable.

The triarylamine dimer compound is represented by general formula (1):

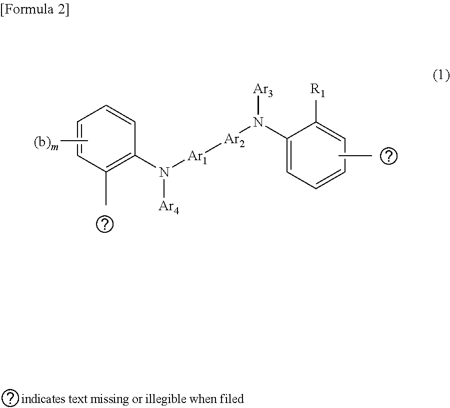

(wherein, Ar₁ and Ar₂ are the same or different and are an unsubstituted or substituted allylene group or an unsubstituted or substituted heterocyclic-induced bivalent group, Ar₃ and Ar₄ are the same or different and are an unsubstituted or substituted aryl group or an unsubstituted or substituted heterocyclic group, R₁ and R₂ are the same or different and are an alkyl group, m and n are an integer of 1 to 4, a and b are the same or different and are a hydrogen atom, a halogen atom, an alkyl group, a fluoroalkyl group, an alkoxy group, or an unsubstituted or substituted amino group, and when m or n is 2 or larger, 2a and 2b bonded to each other at an adjacent position together form a methylenedioxy group, an ethylenedioxy group, a tetramethylene group, or a butadienylene group).

Examples of the triarylamine dimer compound represented by general formula (1) include a compound described in Japanese Patent Publication No. 4604083, which can be synthesized by a method described in this publication.

A specific example is a triarylamine dimer compound (triphenylamine-based compound) having structural formula (a) in which Ar₁ and Ar₂ are a p-phenylene group, Ar₃ and Ar₄ are a phenyl group, R₁ and R₂ are a hydrogen atom, a and b are a methyl group, and exponents n and m are 1, as used in Examples.

The stilbene derivative is represented by general formula (2):

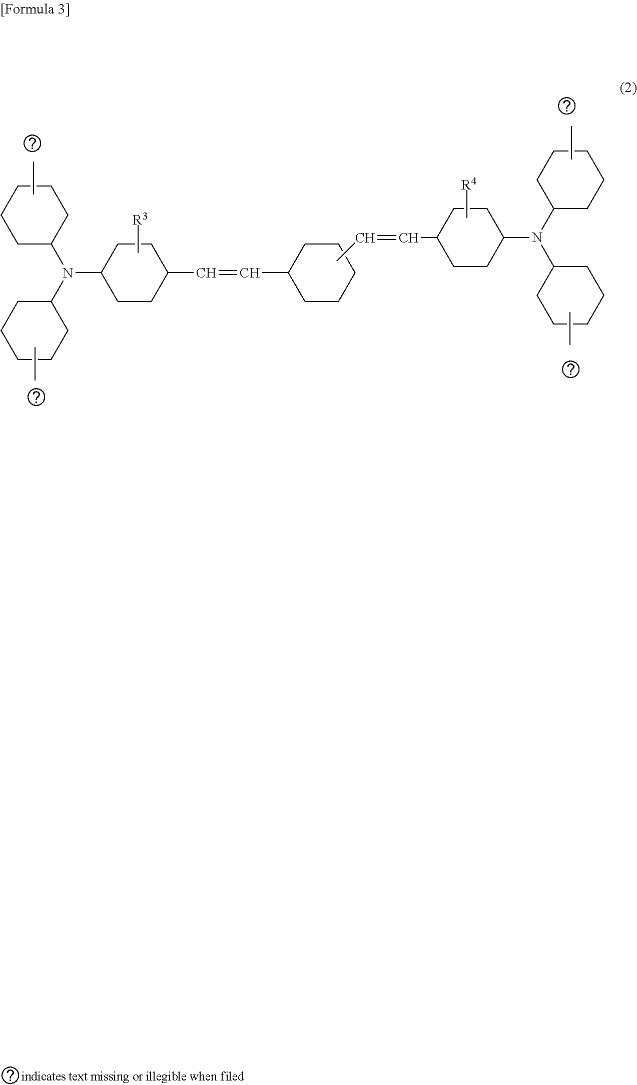

(wherein, R¹, R², R⁵ and R⁶ are the same or different and are an alkyl group, an alkoxy group, an aryl group, an aralkyl group or a halogen atom, m, n, p and q are the same or different and are an integer of 0 to 3, and when R¹ and R² are the same group, m and n are different integers from each other, and when R⁵ and R⁶ are the same group, p and q are different integers from each other, and R³ and R⁴ are the same or different and are a hydrogen atom or an alkyl group).

Examples of the stilbene derivative represented by general formula (2) include a compound described in Japanese Patent Publication No. 3272257, which can be synthesized by a method described in this publication.

A specific example is a stilbene derivative (stilbene-based compound) having structural formula (b) in which R¹, R², R⁵ and R⁶ are a methyl group, R³ and R⁴ are a hydrogen atom, exponents n and p are 1, and exponents m and q are 1, as used in Examples.

Examples of the alkyl group explained for the substituents R¹, R², R⁵ and R⁶ in general formula (2) include

alkyl groups having 1 to 6 carbon atoms such as methyl, ethyl, n-propyl, isopropyl, n-butyl, isobutyl, s-butyl, t-butyl, n-pentyl, and n-hexyl.

Examples of the alkoxy group include alkoxy groups having 1 to 6 carbon atoms such as methoxy, ethoxy, n-propoxy, isopropoxy, t-butoxy, n-pentyloxy, and n-hexyloxy.

Examples of the aryl group include aryl groups such as phenyl, naphthyl, anthryl, phenanthryl, fluorenyl, biphenylyl, and o-terphenyl.

Examples of the aralkyl group include aralkyl groups such as benzyl, phenethyl, benzhydryl, and trityl.

Examples of the halogen atom include fluorine, chlorine, bromine, iodine, and the like.

When the exponents m, n, p and q of the substituents R¹, R², R⁵ and R⁶ are 2 or larger, each substituent may be different from each other, and for example, when the exponent m of the substituent R¹ is 2, different groups may be substituted with each other, e.g. a methyl group and an ethyl group may be substituted with each other, and a methyl group and an ethoxy group may be substituted with each other in the same benzene ring.

Examples of the alkyl group of the substituents R³ and R⁴ in general formula (1) include alkyl groups having 1 to 3 carbon atoms such as methyl, ethyl, n-propyl, and isopropyl.

A method for forming the charge transporting layer is preferably a method in which the charge transporting substance is dispersed in a binder resin solution obtained by mixing a binder resin in a solvent using a conventionally known method, and a coat liquid for the charge transporting layer is applied on the charge generating layer. This method will be explained below.

The binder resin is not particularly limited, a bindable resin used in the art can be used, and a binder resin excellent in compatibility with the charge transporting substance is preferable.

Specific examples of the binder resin include a vinyl polymer resin such as polymethylmethacrylate, polystyrene, and polyvinyl chloride and copolymer resins thereof, as well as a resin such as polycarbonate, polyester, polyester carbonate, polysulfone, phenoxy resin, epoxy resin, silicone resin, polyarylate, polyamide, polyether, polyurethane, polyacrylamide, phenol resin, and polyphenylene oxide, a thermosetting resin obtained by partially crosslinking these resins, and the like. One of these binder resins may be used alone or two or more of these binder resins may be used in combination. Among these binder resins, polystyrene, polycarbonate, polyarylate, and polyphenylene oxide are preferable because they have a volume resistivity value of 10¹³Ω or higher, excellent electric insulation, and excellent film formability and potential property. Among them, polycarbonate is particularly preferable.

Examples of the solvent include: an aromatic hydrocarbon such as benzene, toluene, xylene, and monochlorobenzene; a halogenated hydrocarbon such as dichloromethane and dichloroethane; an ether such as tetrahydrofuran, dioxane, and dimethoxymethyl ether; and an aprotic polar solvent such as N,N-dimethylformamide; and the like. In addition, a solvent such as an alcohol, acetonitrile, and methyl ethyl ketone can be further added and used, as needed. One of these solvents may be used alone or two or more of these solvents may be used in combination.

Among these solvents, for example, a non-halogen organic solvent can be suitably used in consideration of the global environment.

The charge transporting layer may contain additives as long as the effects of the present invention are not impaired.

Examples of the additives include an ultraviolet absorber for improving light resistance, specifically a perinone-based dye as used in Examples.

However, when the additives are added to the charge transporting layer, a charge transport trap is formed, and the properties of the photoreceptor may be adversely affected. An addition amount of the additives is about 1 to 10 parts by mass based on the charge transporting substance.

Preferably, a ratio (G/H) of a mass G of the charge transporting substance to a mass H of the binder resin is e.g. about 10/12 to 10/30.

A film thickness of the charge transporting layer is not particularly limited, but is preferably about 5 to 50 μm, more preferably about 10 to 40 μm.

If the film thickness of the charge transporting layer is less than 5 μm, charge retainability of the photoreceptor surface decreases in some cases. On the other hand, if the film thickness of the charge transporting layer is more than 50 μm, resolution of the photoreceptor decreases in some cases.

### (2) Image Forming Apparatus 100

The image forming apparatus according to the present invention characteristically includes at least the photoreceptor according to the present invention, an electrifier for electrifying the photoreceptor, an exposer for exposing the electrified photoreceptor to form an electrostatic latent image, a developer for developing the electrostatic latent image formed by the exposure to form (visualize) a toner image, a transferer for transferring the toner image formed by the development onto a recording medium, a fuser for fusing the transferred toner image onto the recording medium to form an image, a cleaner for removing and recovering the toner remaining on the photoreceptor, and a charge eliminator for eliminating surface charges remaining on the photoreceptor.

Hereinafter, the image forming apparatus according to the present invention and operations thereof will be explained on the basis of the figures, but the present invention is not limited to the following description.

FIG. 3 is a schematic side view illustrating a configuration of a main part of an image forming apparatus 100 according to the present invention. The image forming apparatus (laser printer) 100 in FIG. 3 is composed of a photoreceptor 1 according to the present invention (corresponding to F01 in FIG. 2), an exposer (semiconductor laser) 31, an electrifier (electrifying device) 32, a developer (developing device) 33, a transferer (transfer electrifying device) 34, a conveyor belt (not illustrated), a fuser (fusing device) 35, and a cleaner (cleaner) 36. Reference numeral 51 represents a recording medium (recording paper or transfer paper).

The photoreceptor 1 is rotatably supported by the main body of the image forming apparatus 100, and rotationally driven around a rotation axis 44 in a direction of an arrow 41 by a driving means not illustrated. The driving means is composed of e.g. an electric motor and a reduction gear, their driving forces are transmitted to a conductive support constituting a core body of the photoreceptor 1, so that the photoreceptor 1 is rotationally driven at a predetermined peripheral velocity. The electrifier (electrifying device) 32, the exposer 31, the developer (developing device) 33, the transferer (transfer electrifying device) 34, and the cleaner (cleaner) 36 are arranged in this order along an outer peripheral face of the photoreceptor 1 from an upstream side to a downstream side in the rotation direction of the photoreceptor 1 indicated by the arrow 41.

The electrifying device 32 is an electrifier for uniformly electrifying the outer peripheral surface of the photoreceptor 1 (corresponding to the photoreceptor F01 in FIG. 2) to a predetermined potential. Examples of the electrifier include a contactless electrification type such as a corona electrification type using an electrification charger, and a contact electrification type using an electrification roller or an electrification brush. The exposer 31 includes a semiconductor laser as a light source, and exposes the outer peripheral surface of the electrified photoreceptor 1 to lights according to image information by irradiating the surface of the photoreceptor 1 between the electrifying device 32 and the developing device 33 with a laser beam light output from the light source. The lights are repeatedly scanned in an extending direction of the rotation axis 44 of the photoreceptor 1 as a main scanning direction, and these lights form an image, so that electrostatic latent images are sequentially formed on the surface of the photoreceptor 1. That means, the presence or absence of laser beam irradiation causes differences in the electrification amount of the photoreceptor 1 uniformly electrified by the electrifying device 32, to form the electrostatic latent images.

The developing device 33 is a developer for developing the electrostatic latent image formed on the surface of the photoreceptor 1 by exposure using a developing powder (toner) and arranged facing the photoreceptor 1, and includes a developing roller 33a for feeing the toner to the outer peripheral surface of the photoreceptor 1, and a casing 33b for supporting the developing roller 33a rotatably around a rotation axis parallel to the rotation axis 44 of the photoreceptor 1 and accommodating the developing powder containing the toner in its own internal space.

The transfer electrifying device 34 is a transferer for transferring a toner image as a visible image formed on the outer peripheral surface of the photoreceptor 1 by development onto a transfer paper 51 that is a recording medium fed to between the photoreceptor 1 and the transfer electrifying device 34 from an arrow 42 direction by means of a conveyor not illustrated. The transfer electrifying device 34 is e.g. a contact-type transferer that includes the electrifier and transfers a toner image onto the transfer paper 51 by applying charges antipolar to the toner onto the transfer paper 51.

The cleaner 36 is a cleaning means for removing and recovering the toner remaining on the outer peripheral surface of the photoreceptor 1 after the transfer operation using the transfer electrifying device 34, and includes a cleaning blade 36a for peeling off the toner remaining on the outer peripheral surface of the photoreceptor 1, and a recovery casing 36b for accommodating the toner peeled off by the cleaning blade 36a. In addition, the cleaner 36 is disposed together with a charge eliminating lamp not illustrated.

In addition, the image forming apparatus 100 has the fusing device 35 as a fuser for fusing the transferred image to the downstream side where the transfer paper 51 that has passed between the photoreceptor 1 and the transfer electrifying device 34 is conveyed. The fusing device 35 includes a heat roller 35a having a heating means not illustrated, and a pressure roller 35b arranged opposite to the heat roller 35a and pressed by the heat roller 35a to form a contact portion.

Reference numeral 37 represents a separator for separating the transfer paper from the photoreceptor, and reference numeral 38 represents a housing for accommodating each of the aforementioned means of the image forming apparatus.

The image forming operation by the image forming apparatus 100 is performed as follows.

First, when the photoreceptor 1 is rotationally driven in the direction of the arrow 41 by the driving means, the surface of the photoreceptor 1 is uniformly electrified to a positive predetermined potential by the electrifying device 32 provided on the upstream side of an image forming point of the light from the exposer 31 in the rotational direction of the photoreceptor 1.

Subsequently, the exposer 31 emits light according to the image information to the surface of the photoreceptor 1. In the photoreceptor 1, the surface charges of the part irradiated with light are removed by this exposure, and a difference is caused between the surface potential of the part irradiated with light and the surface potential of the part not irradiated with light, so that an electrostatic latent image is formed.

From the developing device 33 provided on the downstream side of the image forming point of the light from the exposer 31 in the rotational direction of the photoreceptor 1, the toner is fed to the surface of the photoreceptor 1 on which the electrostatic latent image is formed, and the electrostatic latent image is developed, so that a toner image is formed.

The transfer paper 51 is fed to between the photoreceptor 1 and the transfer electrifying device 34 in synchronization with the exposure to the photoreceptor 1. Charges antipolar to the toner are applied to the fed transfer paper 51 by the transfer electrifying device 34, so that the toner image formed on the surface of the photoreceptor 1 is transferred onto the transfer paper 51.

The transfer paper 51 to which the toner image is transferred is conveyed to the fusing device 35 by the conveyor, and heated and pressurized when passing through the contact portion between the heat roller 35a and the pressure roller 35b of the fusing device 35, and the toner image is fused to the transfer paper 51 to obtain a robust image. The transfer paper 51 on which the image is formed in this way is discharged to the outside of the image forming apparatus 100 by the conveyor.

On the other hand, the toner remaining on the surface of the photoreceptor 1 even after the transfer of the toner image by the transfer electrifying device 34 is peeled off and recovered from the surface of the photoreceptor 1 by the cleaner 36. The charges on the surface of the photoreceptor 1 from which the toner has been removed in this manner are removed by the light from the charge eliminating lamp, and the electrostatic latent image on the surface of the photoreceptor 1 disappears. After that, the photoreceptor 1 is further rotationally driven, and a series of operations starting from electrification are repeated again to continuously form the images.

The image forming apparatus 100 is a monochromatic image forming apparatus (printer), but may be e.g. an intermediate transfer type color image forming apparatus capable of forming a color image. Specifically, the image forming apparatus 100 may be a so-called tandem-type full color image forming apparatus having a configuration in which a plurality of electrophotographic photoreceptors on which toner images are individually formed are arranged side by side in a predetermined direction (e.g. a horizontal direction H, or a substantially horizontal direction H). In addition, the image forming apparatus 100 may be another color image forming apparatus, a copier, a multifunction peripheral, or a facsimile.

### EXAMPLES

Hereinafter, the present invention will be specifically explained with reference to the Production Examples, Comparative Production Examples, Examples, and Comparative Examples, but the present invention is not limited to the following examples as long as the examples do not depart from the gist of the present invention.

As described below, in Examples 1 to 6, 8 to 10 and Comparative Examples 1 to 6, each charge-generating coat liquid produced in Production Examples 1 to 6 and Comparative Production Examples 1 to 3 was prepared as a charge generating substance. An undercoat layer-forming coat liquid, a charge generating layer-forming coat liquid, and a charge transporting layer-forming coat liquid were applied in this order on a substrate to prepare a laminated photoreceptor F01 illustrated in FIG. 2 in which an undercoat layer F21, a charge generating layer F22, and a charge transporting layer F23 were laminated in this order on a substrate F1.

Additionally, in Example 7, a laminated photoreceptor was prepared in the same manner as in Example 1 except that the undercoat layer F21 was not formed.

### Synthesis of Titanyl Phthalocyanine

### Production Example 1

30 parts of 1,3-diiminoisoindoline and 210 parts of sulfolane were mixed, and heated and stirred under a nitrogen stream at 180° C., to which 21 parts of titanium tetrabutoxide was dripped. After completion of the dripping, the mixture was stirred for reaction while maintaining the temperature at 180° C. for 6 hours. After completion of the reaction, the mixture was allowed to cool, then a precipitate was filtered, a powder of the obtained precipitate was washed with chloroform, then carefully washed with methanol, further washed with hot water at 85° C. several times, and then dried to obtain a crude titanyl phthalocyanine.

5 parts of the obtained crude titanyl phthalocyanine washed with hot water was stirred in 100 parts of sulfuric acid at 3 to 5° C. and gradually dissolved, and filtered. If the reaction temperature is higher than 5° C., phthalocyanine may be decomposed, and therefore the temperature was thoroughly managed at 5° C. or lower.

The obtained sulfuric acid solution was dripped little by little into 3500 parts of ice water while stirring. During that time, the temperature of ice water was managed at 5° C. or lower at all times. A precipitated crystal was filtered, and then repeatedly suspended and washed with a washing liquid to obtain a wet cake of the desired titanyl phthalocyanine. A pH of the washing liquid was measured, and from a result being pH 6.8, it was confirmed that deoxidization washing could be achieved.

150 parts of tetrahydrofuran was added to the obtained wet cake, which was stirred by a homomixer at a rotation speed of 2200 rpm at room temperature, and immediately after 1 hour, subjected to vacuum filtration. A crystal obtained on a filtration apparatus was washed with tetrahydrofuran to obtain 9 parts of wet cake of tetrahydrofuran. This wet cake was dried under reduced pressure (5 mmHg) at 70° C. for 2 days to obtain 8 parts of titanyl phthalocyanine crystal. Furthermore, 3 g of the obtained titanyl phthalocyanine crystal was subjected to the second crystallization with tetrahydrofuran, and dried under reduced pressure to obtain a titanyl phthalocyanine crystal of Production Example 1.

3 parts by mass of the obtained titanyl phthalocyanine as a charge generating substance, and 2 parts by mass of a polyvinyl butyral (PVB) resin (trade name: BX-1, manufactured by Sekisui Chemical Company, Limited) as a binder resin were added to 32 parts by mass of cyclohexanone and 128 parts by mass of methyl ethyl ketone, and the mixture was dispersed using glass beads (trade name: BZ-1, manufactured by AS ONE CORPORATION, bead diameter: 1 mm) as a medium in a paint shaker for 0.5 hour to prepare 20 g of a charge generating layer-forming coat liquid.

An obtained dried solid of the charge generating layer-forming coat liquid was measured for an X-ray diffraction spectrum using the following apparatus under the following conditions. The X-ray diffraction spectrum of the dried solid of the coat liquid corresponds to an X-ray diffraction spectrum of the titanyl phthalocyanine contained in the coat liquid.

X-ray diffractometer: Model: ATX-G (for thin film structure evaluation) manufactured by Rigaku Corporation

X-ray source: CuKα=1.541 Å

Voltage: 50 kV

Current: 300 mA

Start angle: 5.0 deg.

Stop angle: 30.0 deg.

Step angle: 0.02 deg.

Measurement time: 5 deg./min.

Measurement method: θ/2θ scanning method

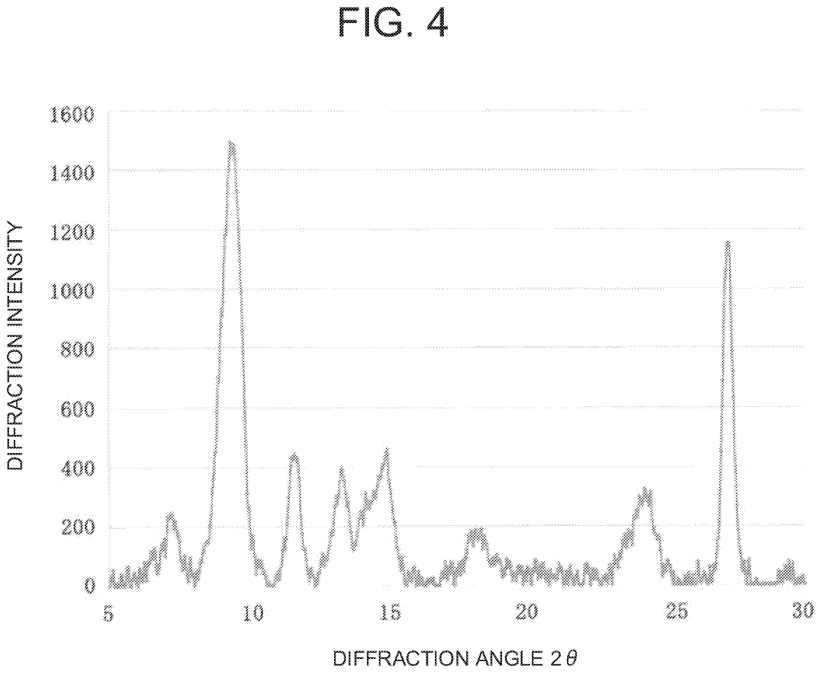

FIG. 4 is a diagram presenting an X-ray diffraction spectrum pattern of titanyl phthalocyanine in Production Example 1. From this figure, it was confirmed that the titanyl phthalocyanine showed diffraction peaks at Bragg angles 7.3°, 9.4°, 11.6°, 24.2° and 27.3°. Also in the following measurement, the X-ray diffraction spectrum pattern of titanyl phthalocyanine was measured in the same manner as above.

Additionally, the obtained charge generating layer-forming coat liquid was measured for an average particle diameter D (50%) of the titanyl phthalocyanine using a laser diffraction type particle size distribution measuring apparatus (model: MICROTRAC MT-3000II, manufactured by Nikkiso Co., Ltd. (current company name: MicrotracBEL Corp.)).

As a result, it was found that the titanyl phthalocyanine in Production Example 1 had an average particle diameter D (50%) of 0.26 μm. Also in the following measurement, the average particle diameter D (50%) of the titanyl phthalocyanine was measured in the same manner as above.

### Production Example 2

40 g of o-phthalodinitrile, 18 g of titanium tetrachloride, and 500 ml of α-chloronaphthalene were heated and stirred under a nitrogen atmosphere at 200 to 250° C. for 3 hours, then allowed to cool to 100 to 130° C., then filtered under heating, and washed with 200 ml of α-chloronaphthalene heated to 100° C. to obtain a crude product of dichlorotitanium phthalocyanine. The obtained crude product was washed with 200 ml of α-chloronaphthalene and then with 200 ml of methanol at room temperature, then further suspended and washed in 500 ml of methanol 5 times, further washed with hot water several times, and then dried to obtain a crude titanyl phthalocyanine.

5 parts of the obtained crude titanyl phthalocyanine washed with hot water was stirred in 100 parts of sulfuric acid at 3 to 5° C. and gradually dissolved, and filtered. If the reaction temperature is higher than 5° C., phthalocyanine may be decomposed, and therefore the temperature was thoroughly managed at 5° C. or lower.

The obtained sulfuric acid solution was dripped little by little into 3500 parts of ice water while stirring. During that time, the temperature of ice water was managed at 5° C. or lower at all times. A precipitated crystal was filtered, and then repeatedly suspended and washed with a washing liquid to obtain a wet cake of the desired titanyl phthalocyanine. A pH of the washing liquid was measured, and from the result being pH 6.9, it was confirmed that deoxidization washing could be achieved.

Tetrahydrofuran as a crystallization solvent was added to the obtained wet cake, which was stirred by a homomixer at a rotation speed of 2200 rpm at room temperature, and after 1 hour, filtered. The filter product was washed with methanol to obtain a titanyl phthalocyanine Furthermore, the titanyl phthalocyanine was subjected to the second crystallization with a mixed solvent of THF:toluene=5:5, and dried under reduced pressure to obtain a titanyl phthalocyanine crystal of Production Example 2.

A charge generating layer-forming coat liquid of Production Example 2 was prepared in the same manner as in Production Example 1 except that the titanyl phthalocyanine crystal of Production Example 2 was used instead of the titanyl phthalocyanine crystal of Production Example 1.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Production Example 3

20 g of charge generating layer-forming coat liquid was prepared in the same manner as in Production Example 2 except that, when preparing the charge generating layer-forming coat liquid in Production Example 2, the mixture was dispersed in a paint shaker using glass beads (trade name: BZ-01, manufactured by AS ONE CORPORATION, bead diameter: 0.1 mm) as a dispersion medium for 0.75 hour.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Production Example 4

20 g of charge generating layer-forming coat liquid was prepared in the same manner as in Production Example 1 except that, when preparing the charge generating layer-forming coat liquid in Production Example 1, the mixture was dispersed using glass beads (trade name: BZ-01, manufactured by AS ONE CORPORATION, bead diameter: 0.1 mm) as a dispersion medium.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Production Example 5

20 g of charge generating layer-forming coat liquid was prepared in the same manner as in Production Example 2 except that, when preparing the charge generating layer-forming coat liquid in Production Example 2, the mixture was dispersed in a paint shaker using a polyvinyl butyral (PVB) resin (trade name: BM-2, manufactured by Sekisui Chemical Company, Limited) as a binder resin for 0.5 hour.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Production Example 6

20 g of charge generating layer-forming coat liquid was prepared in the same manner as in Production Example 1 except that, when preparing the charge generating layer-forming coat liquid in Production Example 1, the mixture was dispersed in a paint shaker was performed using glass beads (trade name: BZ-1, manufactured by AS ONE CORPORATION, bead diameter: 0.1 mm) as a dispersion medium for 0.75 hour.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Comparative Production Example 1

40 g of o-phthalodinitrile, 18 g of titanium tetrachloride, and 500 ml of α-chloronaphthalene were heated and stirred under a nitrogen atmosphere at 200 to 250° C. for 3 hours, then allowed to cool to 100 to 130° C., then filtered under heating, and washed with 200 ml of α-chloronaphthalene heated to 100° C. to obtain a crude product of dichlorotitanium phthalocyanine. The obtained crude product was washed with 200 ml of α-chloronaphthalene and then with 200 ml of methanol at room temperature, then further suspended and washed in 500 ml of methanol 5 times, further washed with hot water several times, and then dried to obtain a crude titanyl phthalocyanine.

5 parts of the obtained crude titanyl phthalocyanine washed with hot water was stirred in 100 parts of sulfuric acid at 3 to 5° C. and gradually dissolved, and filtered. If the reaction temperature is higher than 5° C., phthalocyanine may be decomposed, and therefore the temperature was thoroughly managed at 5° C. or lower.

The obtained sulfuric acid solution was dripped little by little into 3500 parts of ice water while stirring. During that time, the temperature of ice water was managed at 5° C. or lower at all times. A precipitated crystal was filtered, and then repeatedly suspended and washed with a washing liquid to obtain a wet cake of the desired titanyl phthalocyanine. A pH of the washing liquid was measured, and from the result being pH 6.2, it was confirmed that deoxidization washing could be achieved.

Tetrahydrofuran as a crystallization solvent was added to the obtained wet cake, which was stirred by a homomixer at a rotation speed of 2200 rpm at room temperature, and after 1 hour, filtered. The filter product was washed with methanol to obtain a titanyl phthalocyanine Furthermore, the titanyl phthalocyanine was subjected to the second crystallization with a mixed solvent of THF:toluene=9:1, and dried under reduced pressure to obtain a titanyl phthalocyanine crystal of Comparative Production Example 1.

A charge generating layer-forming coat liquid of Comparative Production Example 1 was prepared in the same manner as in Production Example 1 except that the titanyl phthalocyanine crystal of Comparative Production Example 1 was used instead of the titanyl phthalocyanine crystal of Production Example 1.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Comparative Production Example 2

20 g of charge generating layer-forming coat liquid was prepared in the same manner as in Comparative Production Example 1 except that, when preparing the charge generating layer-forming coat liquid in Comparative Production Example 1, the mixture was dispersed using glass beads (trade name: BZ-1, manufactured by AS ONE CORPORATION, bead diameter: 0.1 mm) as a dispersion medium.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Comparative Production Example 3

20 g of charge generating layer-forming coat liquid was prepared in the same manner as in Production Example 5 except that, when preparing the charge generating layer-forming coat liquid in Production Example 5, the mixture was dispersed in a paint shaker was performed using glass beads (trade name: BZ-2, manufactured by AS ONE CORPORATION, bead diameter: 2.0 mm) as a dispersion medium for 1.0 hour.

The X-ray diffraction spectrum of the obtained dried solid of the charge generating layer-forming coat liquid was measured in the same manner as in Production Example 1, and it was confirmed that the dried solid showed diffraction peaks specified in the present invention.

### Example 1

### Formation of Undercoat Layer

3 parts by mass of titanium oxide (trade name: TS-043, manufactured by Showa Denko K.K.) and 2 parts by mass of copolymerized polyamide (nylon) (trade name: CM8000, manufactured by Toray Industries, Inc.) were added to 25 parts by mass of methyl alcohol, which was dispersed in a paint shaker (disperser) for 8 hours to prepare 3 kg of undercoat layer-forming coat liquid. Subsequently, an immersion coating method is performed, specifically, the obtained coat liquid is charged in the coating bath, and a drum-shaped aluminum substrate having a diameter of 30 mm and a length of 357 mm is immersed in the coat liquid, then raised, and dried to form an undercoat layer having a film thickness of 1.0 μm.

### Formation of Charge Generating Layer

Similar to the formation of the undercoat layer, the charge generating layer forming coat liquid obtained in Production Example 1 by the immersion coating method was applied on a surface of the undercoat layer. Specifically, the obtained charge generating layer forming coat liquid is charged in a coating bath, and a drum-shaped substrate on which an undercoat layer is formed is immersed in the coat liquid, then raised, and naturally dried to form a charge generating layer having a film thickness of 0.2 μm.

### Formation of Charge Transporting Layer

104 parts by mass of tetrahydrofuran was added to 10 parts by mass of triphenylamine-based compound (TPD) (trade name: D2448, manufactured by Tokyo Chemical Industry Co., Ltd.) as a charge transporting substance represented by the following structural formula (a):

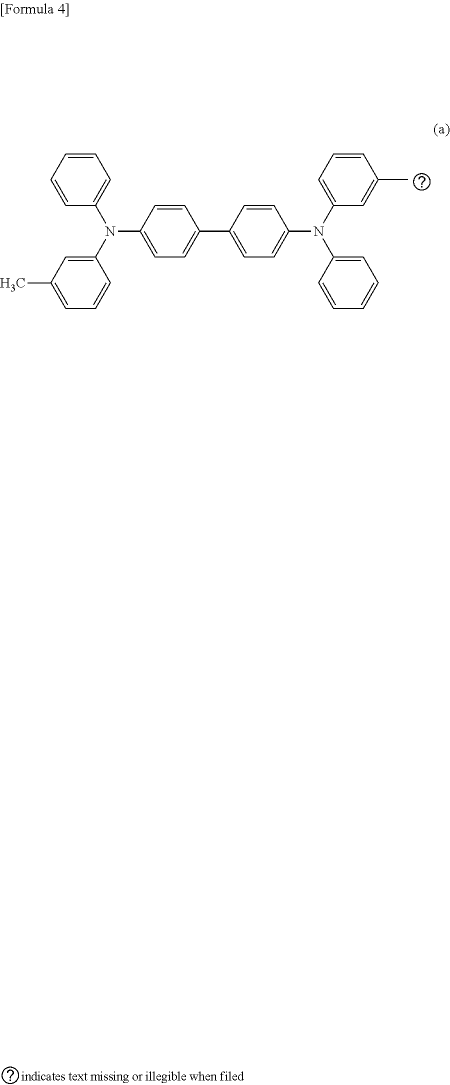

and 20 parts by mass of Z-type polycarbonate (trade name: TS2020, manufactured by Teijin Chemicals Ltd.) as a binder resin, which was stirred and mixed to prepare 3 kg of charge transporting layer-forming coat liquid.

Subsequently, similar to the formation of the undercoat layer, the charge transporting layer-forming coat liquid was applied on the surface of the charge generating layer by the immersion coating method. Specifically, the obtained charge-transporting layer-forming coat liquid is charged in a coating bath, and a drum-shaped substrate on which the charge generating layer is formed is immersed in the coat liquid, then raised, and dried at 130° C. for 1 hour to form a charge transporting layer having a film thickness of 25 μm.

In this way, the photoreceptor F01 illustrated in FIG. 2 was prepared.

The photoreceptive layer of the obtained photoreceptor is peeled off, and an optical absorption spectrum of the photoreceptive layer was measured in a wavelength region 400 to 900 nm using an ultraviolet-visible spectrophotometer (UV-VIS SPECTROPHOTOMETER, model: UV-2450, manufactured by SHIMADZU CORPORATION).

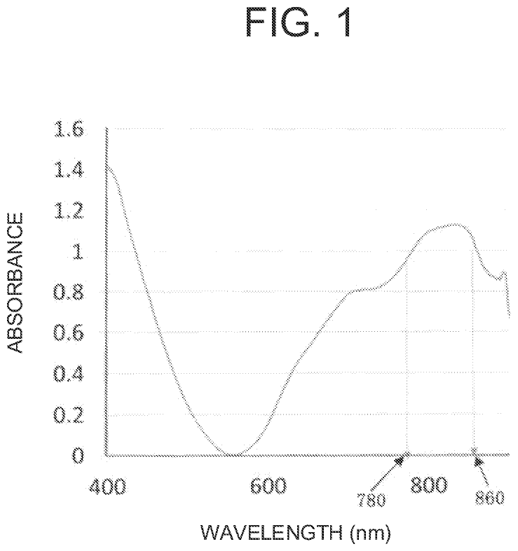

The obtained optical absorption spectrum is presented in FIG. 1.

According to the optical absorption spectrum, the photoreceptive layer showed a maximum absorption at 833 nm, and when a minimum absorbance at 400 to 800 nm was calibrated to 0, a ratio of a peak intensity at 780 nm to a peak intensity at 860 nm was 0.99.

### Examples 2 to 6

Photoreceptors F01 of Examples 2 to 6 were prepared in the same manner as in Example 1 except that each charge generating layer-forming coat liquid obtained in Production Examples 2 to 6 was used as the charge generating layer-forming coat liquid.

### Example 7

A photoreceptor F01 of Example 7 was prepared in the same manner as in Example 1 except that the undercoat layer was not formed on the drum-shaped aluminum substrate.

### Example 8

A photoreceptor F01 of Example 8 was prepared in the same manner as in Example 4 except that 1 part by mass of ultraviolet absorber (trade name: Orange HG, manufactured by KIWA Chemical Industry Co., Ltd., perinone dye, C.I. solvent Orange 60) was added to the charge transporting layer-forming coat liquid.

### Example 9

A photoreceptor F01 of Example 9 was prepared in the same manner as in Example 2 except that a stilbene-based compound represented by the following structural formula (b):

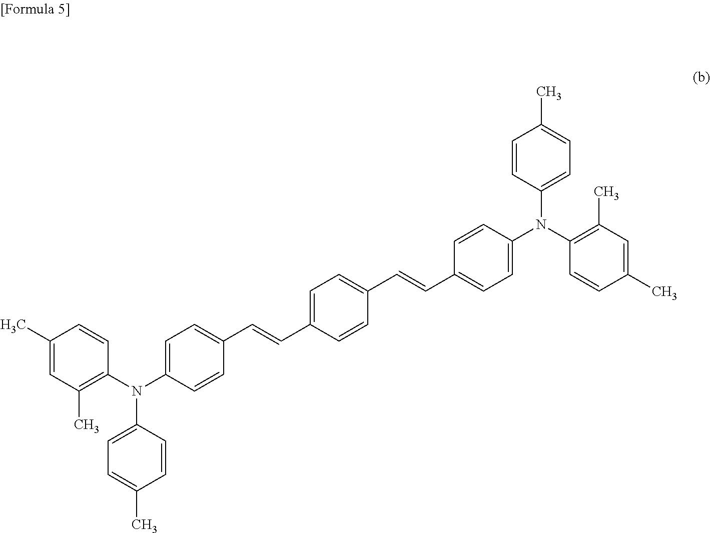

was used as the charge transporting substance of the charge transporting layer.

The compound represented by formula (b) was previously synthesized by a method described in Japanese Patent Publication No. 3272257.

### Example 10

A photoreceptor F01 of Example 10 was prepared in the same manner as in Example 2 except that a butadiene-based compound (trade name: T-405, manufactured by TAKASAGO CHEMICAL CORPORATION, 1,1-bis(para-diethylphenyl)-4,4-biphenyl-1,3-butadiene) represented by the following structural formula (c):

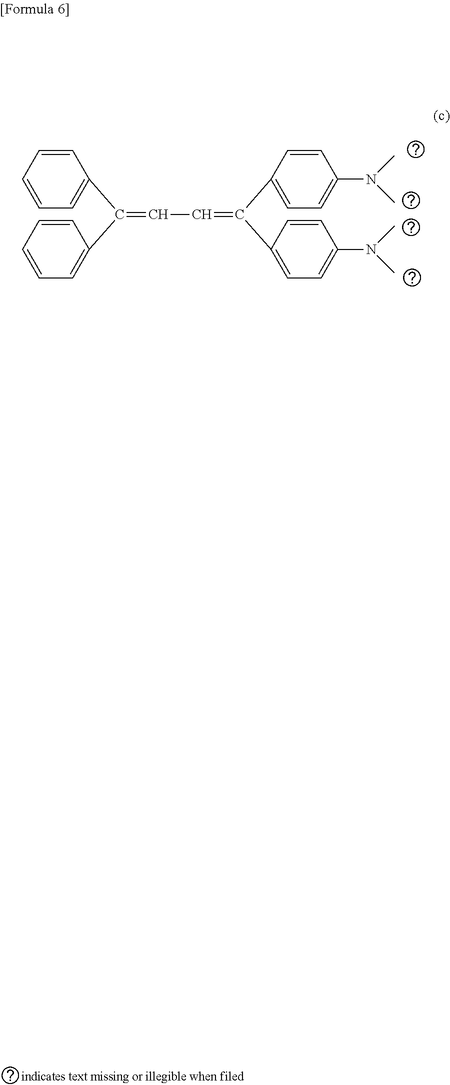 [SMILES: CN(C)c1ccc(C(=CC=C(c2ccccc2)c2ccccc2)c2ccc(N(C)C)cc2)cc1]

was used as the charge transporting substance of the charge transporting layer.

### Comparative Examples 1 and 2

Photoreceptors F01 of Comparative Examples 1 and 2 were prepared in the same manner as in Example 1 except that each charge generating layer-forming coat liquid obtained in Comparative Production Examples 1 and 2 was used as the charge generating layer-forming coat liquid.

### Comparative Example 3

A photoreceptor F01 of Comparative Example 3 was prepared in the same manner as in Comparative Example 1 except that 1 part by mass of ultraviolet absorber (trade name: Orange HG, manufactured by KIWA Chemical Industry Co., Ltd., perinone dye, C.I. solvent Orange 60) was added to the charge transporting layer-forming coat liquid.

### Comparative Example 4

A photoreceptor F01 of Comparative Example 4 was prepared in the same manner as in Comparative Example 1 except that 3 parts by mass of ultraviolet absorber (trade name: Orange HG, manufactured by KIWA Chemical Industry Co., Ltd., perinone dye, C.I. solvent Orange 60) was added to the charge transporting layer-forming coat liquid.

### Comparative Example 5

A photoreceptor F01 of Comparative Example 5 was prepared in the same manner as in Comparative Example 1 except that a butadiene-based compound (trade name: T-405, manufactured by TAKASAGO CHEMICAL CORPORATION) represented by structural formula (c) was used as the charge transporting substance of the charge transporting layer.

### Comparative Example 6

A photoreceptor F01 of Comparative Example 6 was prepared in the same manner as in Example 1 except that the charge generating layer-forming coat liquid obtained in Comparative Production Example 3 was used as the charge generating layer-forming coat liquid.

### Evaluation

The photoreceptors F01 prepared in Examples 1 to 10 and Comparative Examples 1 to 6 were evaluated in relation to the following items using a test copier obtained by modifying a digital copier (trade name: MX-2600, manufactured by SHARP CORPORATION).

### Evaluation 1

The photoreceptor (drum) to be evaluated was wrapped with a light-shielding paper, a 10 mm×30 mm window was formed on the light-shielding paper, the photoreceptor was exposed to a fluorescent light with an illuminance of 400 Lux for 0.5 hour, and then halftone printing was conducted by the test copier. Images before and after the light exposure were compared and evaluated together with printing results before the light exposure.

The obtained results were visually judged in accordance with the following criteria.

VG: Influence on the image cannot be confirmed.

G: ID (Image Density) slightly increases only on the exposed site, but the influence is negligible, and there is no problem in actual use.

B: Influence from the exposed site is obvious and the photoreceptor cannot be used in practice.

### Evaluation 2

The photoreceptor (drum) to be evaluated was placed in the test copier, and subjected to repeated processes only of electrification, exposure, and charge elimination under a low humidity (NL) environment (temperature: 25° C./relative humidity: 10%) 600,000 times. An initial charging potential and a charging potential after energization fatigue were measured, and a difference ΔV₀ therebetween was used as an indicator for decreased electrification under the low humidity environment.

The obtained results were judged in accordance with the following criteria.

VG: Very good (0≤ΔV0<60)

G: Good (60≤ΔV0<80)

NB: Not bad (80≤ΔV0<100)

B: Bad (100≤ΔV0)

### Evaluation 3

The photoreceptor (drum) to be evaluated was placed in the test copier, and subjected to repeated processes only of electrification, exposure, and charge elimination under a high humidity (NH) environment (temperature: 25° C./relative humidity: 85%) 600,000 times. An initial sensitivity potential and a sensitivity potential after energization fatigue were measured, and a surface potential difference ΔVL was measured.

The obtained results were judged in accordance with the following criteria.

VG: Very good (0≤|ΔVL|<30)

G: Good (30≤ΔVL|<60)

NB: Not bad (60≤|ΔVL|<75)

B: Bad (75≤|ΔVL|)

### Comprehensive Evaluation

Based on the judgment results of evaluations 1 to 3, comprehensive judgment was conducted in accordance with the following criteria.

VG: VG was achieved in all judgements of Evaluations 1 to 3.

G: There is no judgment B in the judgments of Evaluations 1 to 3.

B: There is judgment B in the judgments of Evaluations 1 to 3.

The obtained evaluation results are presented in Table 1 together with main constituent materials and physical properties of the photoreceptors.

TABLE 1

| | Photoreceptor | | | | | | |
|---|---|---|---|---|---|---|---|
| | | | | Charge transporting layer | | | |
| | Charge generating layer | | | | Additive** | Laminated photoreceptive layer | |
| | Charge generating substance | | | | Presence | | Peak |
| | | | Average | Charge | or absence | Maximum | intensity |
| | | | particle | transporting | If present, | absorption | ratio |
| | | Raw | diameter | substance | addition | wavelength | Abs_{860 nm}/ |
| | Production | material | D (μm) | Material | amount | λₘₐₓ (nm) | Abs_{780 nm} |
| Example 1 | Production | TTB* | 0.26 | Structural | Absence | 833 | 0.99 |
| | Example 1 | | | formula (a) | | | |
| Example 2 | Production | Titanium | 0.26 | Structural | Absence | 846 | 1.09 |
| | Example 2 | tetrachloride | | formula (a) | | | |
| Example 3 | Production | Titanium | 0.22 | Structural | Absence | 808 | 0.93 |
| | Example 3 | tetrachloride | | formula (a) | | | |
| Example 4 | Production | TTB* | 0.17 | Structural | Absence | 800 | 0.65 |
| | Example 4 | | | formula (a) | | | |
| Example 5 | Production | Titanium | 0.33 | Structural | Absence | 849 | 1.20 |
| | Example 5 | tetrachloride | | formula (a) | | | |
| Example 6 | Production | TTB* | 0.15 | Structural | Absence | 803 | 0.71 |
| | Example 6 | | | formula (a) | | | |
| Example 7 | Production | TTB* | 0.26 | Structural | Absence | 833 | 0.99 |
| | Example 1 | | | formula (a) | | | |
| Example 8 | Production | TTB* | 0.17 | Structural | 1 part by | 800 | 0.65 |
| | Example 4 | | | formula (a) | mass | | |
| Example 9 | Production | Titanium | 0.26 | Structural | Absence | 846 | 1.09 |
| | Example 2 | tetrachloride | | formula (b) | | | |
| Example 10 | Production | Titanium | 0.26 | Structural | Absence | 846 | 1.09 |
| | Example 2 | tetrachloride | | formula (c) | | | |
| Comparative | Comparative | Titanium | 0.21 | Structural | Absence | 804 | 0.49 |
| Example 1 | Production | tetrachloride | | formula (a) | | | |
| | Example 1 | | | | | | |
| Comparative | Comparative | Titanium | 0.17 | Structural | Absence | 794 | 0.37 |
| Example 2 | Production | tetrachloride | | formula (a) | | | |
| | Example 2 | | | | | | |
| Comparative | Comparative | Titanium | 0.21 | Structural | 1 part by | 804 | 0.49 |
| Example 3 | Production | tetrachloride | | formula (a) | mass | | |
| | Example 1 | | | | | | |
| Comparative | Comparative | Titanium | 0.21 | Structural | 3 part by | 804 | 0.49 |
| Example 4 | Production | tetrachloride | | formula (a) | mass | | |
| | Example 1 | | | | | | |
| Comparative | Comparative | Titanium | 0.21 | Structural | Absence | 804 | 0.49 |
| Example 5 | Production | tetrachloride | | formula (c) | | | |
| | Example 1 | | | | | | |
| Comparative | Comparative | Titanium | 0.40 | Structural | Absence | 855 | 1.22 |
| Example 6 | Production | tetrachloride | | formula (a) | | | |
| | Example 3 | | | | | | |

| | Photoreceptor | | | | | | |
|---|---|---|---|---|---|---|---|
| | Undercoat | | | | | | |
| | layer | Evaluation | | | | | |
| | Presence | Evaluation 1 | Evaluation 2 | | Evaluation 3 | | Comprehensive |
| | or absence | Judgement | ΔV₀ | Judgement | ΔVL | Judgement | evaluation |
| Example 1 | Presence | VG | 40 | VG | 25 | VG | VG |
| Example 2 | Presence | G | 55 | VG | 26 | VG | G |
| Example 3 | Presence | VG | 55 | VG | 26 | VG | VG |
| Example 4 | Presence | G | 40 | VG | 25 | VG | G |
| Example 5 | Presence | G | 53 | VG | 38 | G | G |
| Example 6 | Presence | VG | 40 | VG | 32 | G | G |
| Example 7 | Absence | VG | 78 | G | 23 | VG | G |
| Example 8 | Presence | VG | 61 | G | 61 | NB | G |
| Example 9 | Presence | G | 53 | VG | 12 | VG | G |
| Example 10 | Presence | VG | 60 | G | 71 | NB | G |
| Comparative | Presence | B | 83 | NB | 26 | VG | B |
| Example 1 | | | | | | | |
| Comparative | Presence | B | 102 | B | 26 | VG | B |
| Example 2 | | | | | | | |
| Comparative | Presence | B | 92 | NB | 59 | G | B |
| Example 3 | | | | | | | |
| Comparative | Presence | G | 98 | NB | 82 | B | B |
| Example 4 | | | | | | | |
| Comparative | Presence | B | 82 | NB | 72 | NB | B |
| Example 5 | | | | | | | |
| Comparative | Presence | B | 79 | G | 42 | G | B |
| Example 6 | | | | | | | |

*Titanium tetrabutoxide
**Ultraviolet absorber (addition amount is a mass ratio to the charge transporting substance)

The followings can be seen from Table 1.

(1) According to the result of Evaluation 1, in the photoreceptors including the charge generating layer containing the titanyl phthalocyanine satisfying the requirements of the optical absorption spectrum according to the present invention as the charge generating substance (Examples 1 to 10), the light resistance of the photoreceptor is remarkably improved compared to the conventional photoreceptors (Comparative Examples 1 to 6).

(2) In the photoreceptors satisfying the requirement that the optical absorption spectrum peak intensity ratio Abs₈₆₀ nm/Abs_{780 nm} of the titanyl phthalocyanine is 0.75 or more to 1 or less (Examples 1, 3 and 6), the light resistance of the photoreceptor is more improved compared to the photoreceptors not satisfying this requirement (Examples 2, 4 and 5).

(3) According to the result of Evaluation 2, in the photoreceptor including the undercoat layer between the aluminum substrate and the charge generating layer (Example 1), the ΔV₀ under the low humidity environment can be more effectively decreased compared to the photoreceptor including no undercoat layer (Example 7).

(4) According to the result of Evaluation 3, in the photoreceptor satisfying the requirement that the average particle diameter D (50%) of titanyl phthalocyanine is 0.15 to 0.3 μm (Example 1), the ΔVL under the high humidity environment can be decreased compared to the photoreceptors not satisfying this requirement (Examples 5 and 6).

(5) Even in the photoreceptor not satisfying the requirement that the optical absorption spectrum peak intensity ratio Abs_{860 nm}/Abs_{780 nm} of the titanyl phthalocyanine is 0.75 or more to 1 or less (Example 4), the light resistance can be improved by combining the charge transporting layer with an additive for improving the light resistance (ultraviolet absorber) (Example 8).

However, when the additive is added to the charge transporting layer, a charge transport trap is formed and the ΔVL under the high humidity environment becomes poor, and therefore the photoreceptor satisfying the above requirement of the optical absorption spectrum peak intensity ratio can maintain a more stable image property for a long term.

(6) As the charge transporting substances, the photoreceptor using the triarylamine dimer compound represented by general formula (1) (Example 2) and the photoreceptor using the stilbene derivative represented by general formula (2) (Example 9) show tendencies of being superior in the effect of decreasing the ΔV₀ under the low humidity environment and the effect of decreasing the ΔVL under the high humidity environment and being somewhat inferior in the light resistance, compared to the photoreceptor using a compound as a general charge transporting substance (Example 10) (this tendency can also be confirmed in comparison between Comparative Example 1 and Comparative Example 5).

However, as aforementioned in (5), by using the titanyl phthalocyanine having the optical absorption spectrum peak intensity ratio within a more preferable range, it is possible to provide a photoreceptor having a sufficiently improved light resistance, extremely preferable ΔV₀ and ΔVL, and image properties stable for a long term.

The present invention is not limited to the embodiments described above, and can be implemented in various other forms. Thus, these embodiments are merely examples in all respects and should be interpreted as unrestrictive. The scope of the present invention is stipulated by claims, and is not bound by the text of the specification at all. Furthermore, all modifications and changes belonging to the scope equivalent to claims are within the scope of the present invention.

What is claimed is:

1. An electrophotographic photoreceptor comprising at least a laminated photoreceptive layer in which a charge generating layer containing a charge generating substance and a charge transporting layer containing a charge transporting substance are laminated in this order on a substrate, wherein
the charge generating substance is a titanyl phthalocyanine showing diffraction peaks at least at Bragg angles (2010.2°) 7.3°, 9.4°, 11.6°, 24.2° and 27.3° in an X-ray diffraction spectrum using CuKα ray, and
the laminated photoreceptive layer includes an optical absorption spectrum that has a maximum absorption at 800 to 850 nm and where a ratio Abs_{860 nm}/Abs_{780 nm} of a peak intensity at 860 nm (Abs_{860 nm}) to a peak intensity at 780 nm (Abs_{780 nm}) is 0.6 or more to 1.2 or less when a minimum absorbance at 400 to 800 inn is calibrated to 0.

2. The electrophotographic photoreceptor according to claim 1, wherein the ratio Abs_{860 nm}/Abs_{780 nm} is 0.75 or more to 1 or less.

3. The electrophotographic photoreceptor according to claim 1, wherein the titanyl phthalocyanine has an average particle diameter D (50%) of 0.15 to 0.3 μm.

4. The electrophotographic photoreceptor according to claim 1, wherein the charge transporting substance is a triarylamine dimer compound represented by general formula (1): 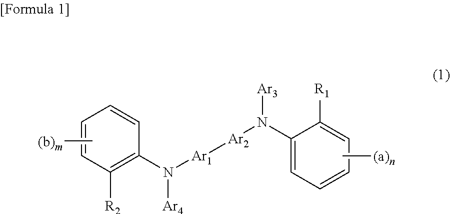
(wherein, Ar₁ and Ar₂ are the same or different and are an unsubstituted or substituted allylene group or an unsubstituted or substituted heterocyclic-induced bivalent group, Ar₃ and Ar₄ are the same or different and are an unsubstituted or substituted aryl group or an unsubstituted or substituted heterocyclic group, R₁ and R₂ are the same or different and are an alkyl group, m and n are an integer of 1 to 4, a and b are the same or different and are a hydrogen atom, a halogen atom, an alkyl group, a fluoroalkyl group, an alkoxy group, or an unsubstituted or substituted amino group, and when m or n is 2 or larger, 2a or 2b bonded to each other at an adjacent position together form a methylenedioxy group, an ethylenedioxy group, a tetramethylene group, or a butadienylene group), or
a stilbene derivative represented by general formula (2): 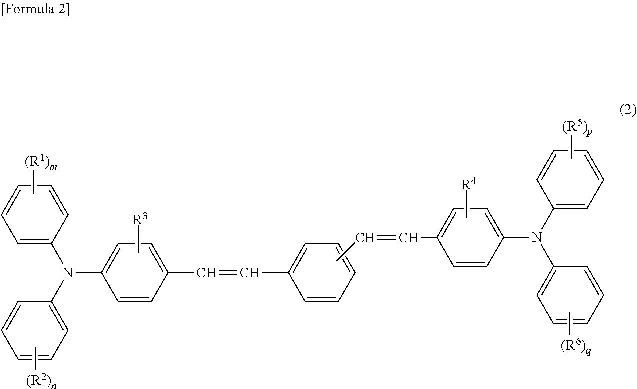
(wherein, R¹, R², R⁵ and R⁶ are the same or different and are an alkyl group, an alkoxy group, an aryl group, an aralkyl group or a halogen atom, m, n, p and q are the same or different and are an integer of 0 to 3, and when R¹ and R² are the same group, m and n are different integers from each other, and when R⁵ and R⁶ are the same group, p and q are different integers from each other, and R³ and R⁴ are the same or different and are a hydrogen atom or an alkyl group).

5. The electrophotographic photoreceptor according to claim 1, comprising an undercoat layer between the substrate and the laminated photoreceptive layer.

6. An image forming apparatus comprising at least the electrophotographic photoreceptor according to claim 1, an electrifier that electrifies the electrophotograpbic photoreceptor, an exposer that exposes the electrified electrophotographic photoreceptor to form an electrostatic latent image, a developer that develops the electrostatic latent image formed by the exposure to form a toner image, a transferer that transfers the toner image formed by the development onto a recording medium, a fuser that fuses the transferred toner image onto the recording medium to form an image, a cleaner that removes and recovers a toner remaining on the electrophotographic photoreceptor, and a charge eliminator that eliminates surface charges remaining on the electrophotographic photoreceptor.
